(19) United States
(12) Patent Application Publication
(10) Pub. No.: US 2012/0181804 A1
(43) Pub. Date: Jul. 19, 2012

(54) VACUUM GRIPPER FOR PICKING UP AND SETTING DOWN UNIT LOADS

(75) Inventors: Kolja Schmidt, Bremen (DE); Wolfgang Echelmeyr, Osterholz-Scharmbeck (DE); Hermann Franck, Ritterhude (DE)

(73) Assignee: Deutsche Post AG, Bonn (DE)

(21) Appl. No.: 13/498,805

(22) PCT Filed: Sep. 22, 2010
(86) PCT No.: PCT/EP2010/005796

§ 371 Date: Mar. 28, 2012

(30) Foreign Application Priority Data
Sep. 28, 2009 (DE) 102009043043.1

(51) Int. Cl. B25J 15/06

(52) U.S. Cl. 294/185

(57) ABSTRACT

A vacuum gripper is provided for picking up and setting down unit loads by layer, comprising a surface having suction openings, connected to a vacuum supply, and device for temporarily connecting the suction openings. The vacuum gripper comprises at least two air channels, connecting suction openings. Each air channel is connected by a valve to a central, linear vacuum supply channel connected to the vacuum supply. The valve comprises at least one tappet, whose movement makes possible controlling opening and closing the valve. The tappets are arranged in a straight row, and are automatically moved in a position where the valve is closed. The tappets are functionally connected to a mechanical actuating device, extending along the row, comprising mechanically movable control elements for sequential actuation. The control elements automatically restore the tappets to a position where the valve is closed, making possible closing the related valves sequentially.

### CROSS-REFERENCE TO RELATED APPLICATIONS

Pursuant to 35 U.S.C. §371, this application is the United States National Stage Application of International Patent Application No. PCT/EP2010/005796, filed on Sep. 22, 2010, the contents of which are incorporated by reference as if set forth in their entirety herein, which claims priority to German (DE) Patent Application No. 10 2009 043 043.1, filed Sep. 28, 2009, the contents of which are incorporated by reference as if set forth in their entirety herein.

### BACKGROUND

Vacuum grippers are often used to transfer unit loads from a first position to a second position. Various devices and methods are known from the state of the art with which objects can be transferred in the most automated way possible. Particularly when it comes to picking goods from containers, pallets or other product carriers, it has proven to be advantageous to use robots that can replace manual work. Aside from loading containers and pallets, robots can also automatically unload them in order to move unit loads from the transportation means in question to a new position.

An application field for robots includes the loading and unloading of essentially rectangular parcels in which goods are packaged that are, for example, wrapped in boxes, cartons or film. Postal parcels can also be transferred by robots.

Such robots can use various gripping devices for picking up objects from a first position and subsequently releasing the objects in a second position. The gripping devices are normally adapted to the shape and size of the object in question. For example, tong-like grippers, lifting mechanisms in the form of plates or forks, as well as vacuum devices can be used.

The German laid-open document DE 28 28 860 A1, for example, discloses a device for loading and unloading pallets which, as an outrigger type, has a gripping head that can be moved in three directions and swiveled around a perpendicular axis. Thus, a parcel can be picked up from a conveyor belt and placed precisely onto a pallet that has been positioned next to the conveyor belt. The placement is effectuated by an automation unit that is controlled by a programming matrix. The gripping head can consist of a vacuum device or a fork.

It is normally desirable to carry out the loading and unloading procedures as quickly as possible. In this context, picking up and transferring objects individually entail a considerable loss of time, so that a device according to the principle of German laid-open document DE 28 28 860 A1 cannot achieve a quick transfer of all of the objects on a pallet. Furthermore, individually picking up objects calls for a precise orientation of the object in a pick-up position and/or a very precise actuation of the gripping device. Therefore, in some fields of application, preference is given to picking up multiple objects simultaneously.

In order to be able to remove the top layer from a stack of objects having the same shape, even though there are individual positions in the top layer that are not occupied by objects, European patent specification EP 0 616 962 B1 proposes, for example, a method for detecting the number of rows of objects of the top layer in a stack on a pallet. In this process, sensors with detector cells ascertain the absence of objects and then actuate the gripping means accordingly. This is an effective but very complex method for picking up multiple objects.

Furthermore, objects of different heights are often present in one layer, and this has to be taken into account during the picking up procedure. This is the case, for example, in the postal sector, where parcels of different sizes are transported on a pallet.

For this purpose, European patent specification EP 0 550 114 B1 discloses a device for simultaneously gripping and moving several objects of different sizes. Towards this end, the device uses multiple suction heads that are lowered onto a layer of objects that are to be picked up. Since the objects can have different heights, the suction heads are lowered to differing extents so that, when a negative pressure is applied to each suction head, the entire layer of objects can be picked up at the same time. The gripping device is raised and then lowered again in a different position in order to once again simultaneously release the objects by relieving the negative pressure. In any case, however, this is a complicated construction involving several sensors and moving parts, which makes the device very prone to malfunctions.

Moreover, it is often the case that it is not an entire layer of objects that is to be set down all at once, but rather the objects are to be positioned one after the other, for example, on a conveyor belt, in order to be transported from there to the next processing station. For this purpose, the objects are normally picked up in rows and then set down again in the same rows. This does not permit entire layers to be transferred, but rather, a layer has to be removed one row at a time, which once again entails a loss of time.

Moreover, German laid-open document DE 103 52 279 A1 describes a device for handling objects that sequentially aligns and sets down the picked-up objects. When multiple objects are picked up, the only gripping elements to be actuated are the ones that are required to pick up the regularly or irregularly arranged objects of one layer. However, this calls for sensor information in order to actively actuate individual gripping elements. This approach of acquiring and evaluating sensor information in order to determine the dimensions and orientation of every single object is likewise a complex and malfunction-prone method.

German laid-open document DE 10 2008 044 948 A1 also discloses a vacuum device, especially for picking up veneer sheets, with which individual lifting elements can be controlled by means of a control device having a light source. The device receives information from a camera about the arrangement of the veneer sheets on a stack, and this information is used by the device for purposes of making logical decisions as to which veneer sheet or sheets should be lifted up. On the basis of these decisions, the individual lifting elements are actuated independently from each other in order to systematically pick up the selected veneer sheets. Consequently, this approach also calls for a sensor system and for an evaluation of the measured values.

Based on this, a device and a method for transferring unit loads between two positions were developed as described in German laid-open document DE 10 2006 062 528 A1. Here, a gripping device with several gripping elements is provided, which can pick up multiple unit loads at the same time. The gripping effect of the individual gripping elements can be eliminated independently of each other, whereby this gripping effect is eliminated sequentially according to a fixed program. The gripping effect of the gripping elements is thus eliminated sequentially after each transfer procedure according to the same program, as a result of which multiple unit loads of a layer that have been picked up simultaneously are now released sequentially. In this manner, it is possible to not only transfer unit loads without complex sensor systems, but also to achieve the individuation of a layer.

A gripping device for carrying out such a method and the associated gripping elements can be configured in different ways. However, it is apparent that an especially advantageous approach is to use vacuum grippers with which a unit load can be picked up by the top using negative pressure and then transferred. In order to release the unit load picked up in this manner, the negative pressure can simply be relieved, as a result of which the unit load drops or can be set down.

### SUMMARY

An embodiment relates to vacuum grippers for picking up unit loads one layer at a time and setting them down sequentially, comprising a suction surface having a plurality of suction openings, which are connected to a vacuum source, and an actuator for temporarily connecting the suction openings to said vacuum source.

The vacuum gripper according to an embodiment is suitable for picking up one layer of unit loads at a time and setting them down sequentially, whereby it comprises a suction surface having multiple suction openings that are connected to a vacuum source, as well as an actuator for temporarily connecting the suction openings to this vacuum source. According to the embodiment, the vacuum gripper also has at least two air channels that each connect several suction openings to each other, whereby each air channel has at least one valve with a central, rectilinear vacuum-source channel that is connected to the vacuum source. The at least one valve comprises at least one tappet whose movement can control the opening and closing of the valve, whereby the tappet is automatically moved into a position in which the associated valve is closed, and the tappets are arranged in a straight row of tappets. Moreover, in order for the tappets to be actuated, the tappets are functionally connected to a mechanical actuator that extends along the row of tappets and that has mechanically movable control elements for purposes of sequentially actuating the tappets. Here, the control elements are configured to consecutively actuate the means for automatically returning the tappets to a position in which the associated valve is closed, as a result of which the associated valves along the row of tappets can be closed.

In an embodiment, the mechanical actuator comprises a driven control chain that runs around at least two deflection rollers and that extends along the row of tappets. Several control members in a row of control members are attached as control elements to the control chain in such a way that the control members are directly or indirectly in contact with a tappet, thereby moving the tappet into a position in which the associated valve is opened when a control member is in the vicinity of the associated tappet while the control chain runs around the two deflection rollers. In contrast, the tappet can be moved by the means for automatically returning the tappets to a position in which the associated valve is closed if no control member is present in the vicinity of the tappet in question.

The control members may be configured to be rectangular-shaped and arranged next to each other along the control chain in the form of a row of control members in such a way that the length of the row of control members corresponds to at least the length of the row of tappets. Here, at least the first and the last control members of the row of control members can have a top that is slanted towards the control chain.

In order to position control elements above the row of tappets, the control chain can run in at least one guide rail.

The two running segments of the control chain that are formed between the two deflection rollers may be located in one plane with the row of tappets.

In another embodiment, the mechanical actuator has a driven camshaft that extends along the row of tappets, whereby several cams are installed as control elements offset with respect to each other on the outer circumference of the camshaft in such a way that, when the camshaft turns, the cams make contact with the tappets directly or indirectly along the row of tappets, thereby consecutively moving the tappets into a position in which the associated valve is closed. In this process, the cams actuate automatically returning the tappets to a position in which the associated valve is closed, and the number of cams corresponds to at least the number of tappets.

In an embodiment of this variant of the actuator, the cams are each indirectly in contact with the tappets via a catch and a tilting lever. Above each tappet, there is a swivel-mounted tilting lever that makes contact with the tappet, and a catch is spring-mounted around a centered axis of rotation, whereby the catch has a hook-shaped latch on one end and a contact area on the other end. A tilting lever can be moved by a closing bar into a position in which a swiveling end of the tilting lever extends underneath the latch of the associated catch and latches under the latch, whereby, when the camshaft rotates around its longitudinal axis, the cams consecutively make contact with the contact area of each catch. The contact of a cam with the contact area of a catch causes the catch to rotate around its axis of rotation, as a result of which the associated tilting lever is released from the latch and automatically returning the tappets to a position in which the associated valve is closed is actuated.

The camshaft can be rotated, for example, by a drive chain that engages with the outer circumference of the camshaft.

A closing bar may be provided that extends over all of the tilting levers. As a result, the closing bar can move all of the tilting levers simultaneously into a position in which a swiveling end of each tilting lever extends underneath the latch of the associated catch and latches under the latch.

In an embodiment, a spring mounting of the tappets may automatically return the tappets to a position in which the associated valve is closed.

In both of these embodiments of the actuator, the vacuum gripper has a body, and at least one valve opening is made in this body for each valve in the area of the vacuum-source channel, whereby this valve opening connects the vacuum-source channel to the associated air channel and it can be opened and closed by a valve body. Here, the tappet installed on the valve body passes through a tappet guide in the vacuum-source channel and leads out of the vacuum-source channel, and it can be contacted by the control elements of the mechanical actuator outside of the vacuum-source channel.

The valve body can be a sealing plate with which the valve opening can be closed. The sealing plate may be located inside an air channel, and the tappet installed on the sealing plate passes through a tappet receptacle from the air channel into the vacuum-source channel, and through the tappet guide out of the vacuum-source channel, whereby the sealing plate covers the valve opening from the side of the air channel and releases it when the associated tappet is moved.

In one embodiment, automatically returning the tappets to a position in which the associated valve is closed may be configured in such a way that it pushes the sealing plate, together with the tappet, in the direction of the mechanical actuator.

The vacuum gripper according to an embodiment can mechanically vent the air channels having several suction openings sequentially, one row at a time. Packaged items that had previously been picked up one layer at a time can thus be set down or dropped individually. Here, the movement of the mechanism can be triggered by just one signal, resulting in a controlled rotational and repeatable movement. The vacuum gripper according to an embodiment does not use a complex and sensitive sensor system, as a result of which it can also be used in work areas where such sensor systems could be negatively affected by influences from the environment. Rather, a standardized individuation of unknown packing patterns is carried out, largely dispensing with sensor systems and differentiated circuits.

The degree of individuation can be adjusted through the speed of the mechanical actuator. If the air channels are vented rapidly in succession, the packaged items drop quickly one after the other, whereas the time interval between two packaged items is greater at lower speeds.

### BRIEF DESCRIPTION OF THE DRAWINGS

The drawings show the following:

FIG. 1 is a schematic depiction of the basic principle of the vacuum gripper according to an embodiment, in a first cross section;

FIG. 2 is an enlarged section of the vacuum gripper according to FIG. 1;

FIG. 3 is a schematic depiction of the vacuum gripper according to FIG. 1, in a second cross section;

FIG. 4a is a schematic depiction of the vacuum gripper according to FIG. 1, in a top view;

FIG. 4b is a schematic depiction of the vacuum gripper according to FIG. 1, in a bottom view;

FIG. 5 is an enlarged section of the cross section according to FIG. 3, with an open valve;

FIG. 6 is an enlarged section of the cross section according to FIG. 3, with a closed valve;

FIG. 7 is a first embodiment of the vacuum gripper according to FIG. 1, with a mechanical actuator having a control chain;

FIG. 8 is the embodiment of the vacuum gripper according to FIG. 7, with completely opened valves and picked-up unit loads;

FIG. 9 is the embodiment of the vacuum gripper according to FIG. 7, at the beginning of a set-down cycle;

FIG. 10 is the embodiment of the vacuum gripper according to FIG. 7, in the middle of a set-down cycle;

FIG. 11 is the embodiment of the vacuum gripper according to FIG. 7, at the end of a set-down cycle;

FIG. 12 is a second embodiment of the vacuum gripper according to FIG. 1, with a mechanical actuator having a camshaft;

FIG. 13 is a top view of a vacuum gripper according to FIG. 12;

FIG. 14a is an enlarged section of the mechanical actuator according to FIG. 12, with closed valves;

FIG. 14b is an enlarged section of the mechanical actuator according to FIG. 12, during the opening of the valves;

FIG. 14c is an enlarged section of the mechanical actuator according to FIG. 12, during the closing of the valves;

FIG. 15 is the embodiment of the vacuum gripper according to FIG. 12, with completely open valves and picked-up unit loads;

FIG. 16 is the embodiment of the vacuum gripper according to FIG. 12, at the beginning of a set-down cycle;

FIG. 17 is the embodiment of the vacuum gripper according to FIG. 12, in the middle of a set-down cycle;

FIG. 18 is the embodiment of the vacuum gripper according to FIG. 12, at the end of a set-down cycle; and

FIG. 19 is a possible application example of the vacuum gripper according to an embodiment.

### DETAILED DESCRIPTION OF SPECIFIC EMBODIMENTS

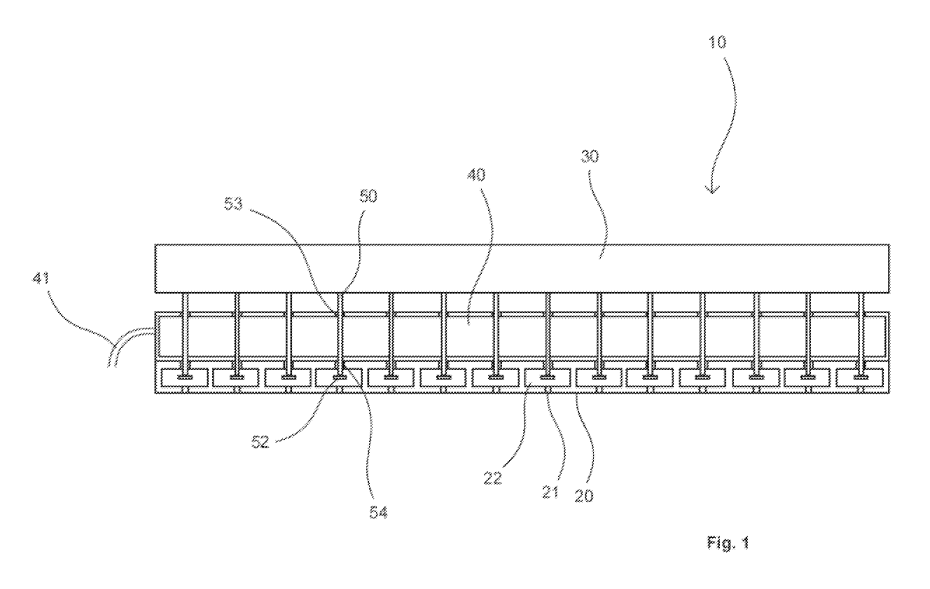

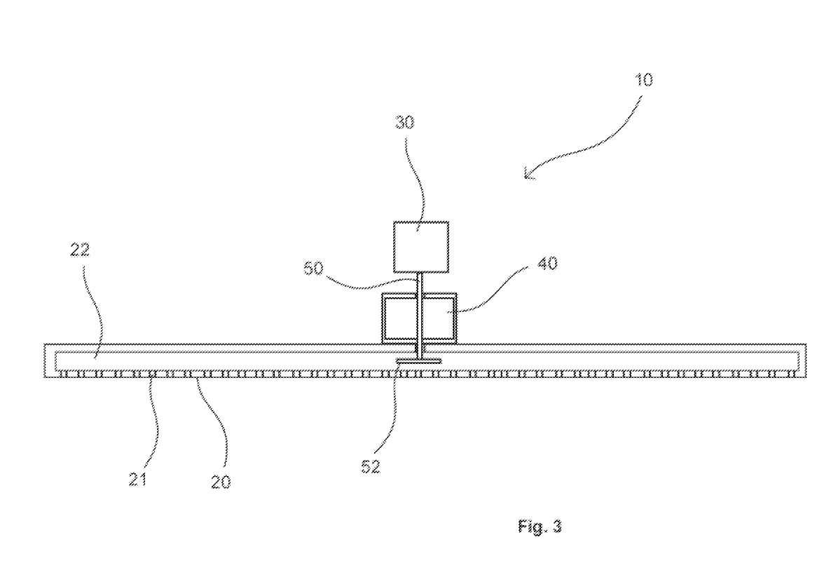

FIG. 1 shows a schematic depiction of the fundamental principle of the vacuum gripper according to an embodiment, in a first cross section. As a supplement to this, FIG. 3 shows a corresponding cross section in a plane perpendicular to the sectional plane of FIG. 1. The vacuum gripper 10 is a full-surface vacuum gripper comprising a body with a lower suction surface 20 in which multiple suction openings 21 have been made. Here, the suction openings 21 are arranged in the suction surface 20 in several rows and columns. Conventional full-surface suction mats made of a foamed material can be glued to this suction surface 20. This type of suction rubber can improve the contact with the unit loads that are to be picked up, whereby a piece of suction rubber can simply be replaced when it wears out.

In an embodiment, the full-surface suction mats and thus the vacuum gripper 10 have a length in the order of magnitude of 1200 mm and a width in the order of magnitude of 800 mm. With such a vacuum gripper having the dimensions of a EuroPallet, packaged items can be picked up from a EuroPallet, transferred and set down again one layer at a time.

In order for negative pressure to be present only at the suction openings that are located on the surface area of a packaged item, additional closing valves can be provided in the suction openings 21. The openings of the negative pressure gripper are automatically closed by a ball valve (not shown here), so that negative pressure can build up in the associated air channel. Such valve techniques are known from the state of the art and are offered, for example, in the product UniGripper® made by Fluidtechnik Bückeburg GmbH.

Here, multiple suction openings 21 are connected to each other within the body of the vacuum gripper 10 via an associated air channel 22. In one embodiment, fourteen air channels are provided so that fourteen rows of suction openings are formed. The number of suction openings per air channel depends on the desired density of the suction openings.

Each air channel 22 is connected via a valve to a vacuum-source channel 40 which, in turn, is connected to a vacuum-source channel 41 (not shown here), that is connected to the vacuum-source channel 40, for example, via a hose. An option as the source of the vacuum is, for example, a side channel compressor. The vacuum-source channel 40 is sealed so as to be airtight vis-à-vis the environment and, together with the air channels 22, it forms a sealed negative pressure area. Consequently, by means of the vacuum-source channel 40 and the opening of a valve that connects the two areas, negative pressure can be generated in each air channel 22 so that packaged items can be picked up by the suction openings 21 of each air channel and held there. In this case, the negative pressure is not present at individual suction openings but rather at all of the suction openings of an air channel, as a result of which negative pressure can be built up and relieved again row by row.

In an embodiment, a valve is formed by a tappet 50 and a valve body 52 that can open and close a valve opening 51 between the vacuum-source channel 40 and the associated air channel 22. The valve is opened and closed by a movement of the tappet 50 that is installed on the valve body 52. Plates, balls, cones or elements having other shapes that are suitable for closing a valve opening, that may be airtight, can all be used as the valve body 52. In the embodiment of FIG. 1, a sealing plate 52 that can close at least one valve opening 51 is used as the valve body. A sealing plate 52 is arranged inside each air channel. The associated tappet 50 extends through a tappet receptacle 54 from the associated air channel 22 into the vacuum-source channel 40, and through a tappet guide 53 from the vacuum-source channel 40 into an area outside of the vacuum-source channel. Thus, each tappet 50 can be actuated manually outside of the negative pressure area.

When the tappet and thus the sealing plate 52 move upward, a valve opening is closed and thus no negative pressure is built up through the vacuum-source channel 40 in the associated air channel. When the tappet and the sealing plate move downward, the valve opening is freed and negative pressure can be built up in the associated air channel.

A valve and thus a tappet 50 are provided for each air channel 22, whereby the tappet 50 is arranged along a row of tappets that, like the vacuum-source channel 40, is located in the middle of the air channels 22, and the vacuum-source channel and the row of tappets extend perpendicular to the lengthwise extension of the air channels. The vacuum-source channel 40 as well as the row of tappets extend approximately along a straight line. Fourteen tappets are provided for fourteen air channels, and these tappets project out of the vacuum-source channel 40 in the form of a row of tappets.

For purposes of consecutively actuating the fourteen tappets manually outside of the negative pressure area, a mechanical actuator 30 is provided that extends above the vacuum-source channel 40 and the row of tappets in the embodiment of the invention shown in FIG. 1. Consequently, the actuator likewise runs approximately in a straight line. However, it does not have to be arranged above the vacuum-source channel 40 and the row of tappets, but rather, it is also possible to arrange them offset thereto.

The actuator 30 may be configured in such a way that it has mechanically movable control elements for sequentially moving the tappet 50, so that the tappet 50 can be moved along the row of tappets by these control elements, as a result of which the associated valves can be closed one after the other. Thus, the negative pressure in the air channels can be relieved one row at a time, so that the previously picked-up packaged items are released from the suction surface. Here, depending on the design of the actuator 30, a valve can be closed when a control element is located in the area of a tappet or vice versa.

Furthermore, in an embodiment, the valves close automatically when returning the tappets is actuated by the control elements of the actuator. In this context, this does not have to be an active actuation but rather, the movement of a control element can also merely free the means for automatically returning a valve. This would be the case, for example, with tappets that are spring-mounted in a tappet guide and that, due to the spring force, move back into a position in which the associated valve is closed when the spring force is released by a control element.

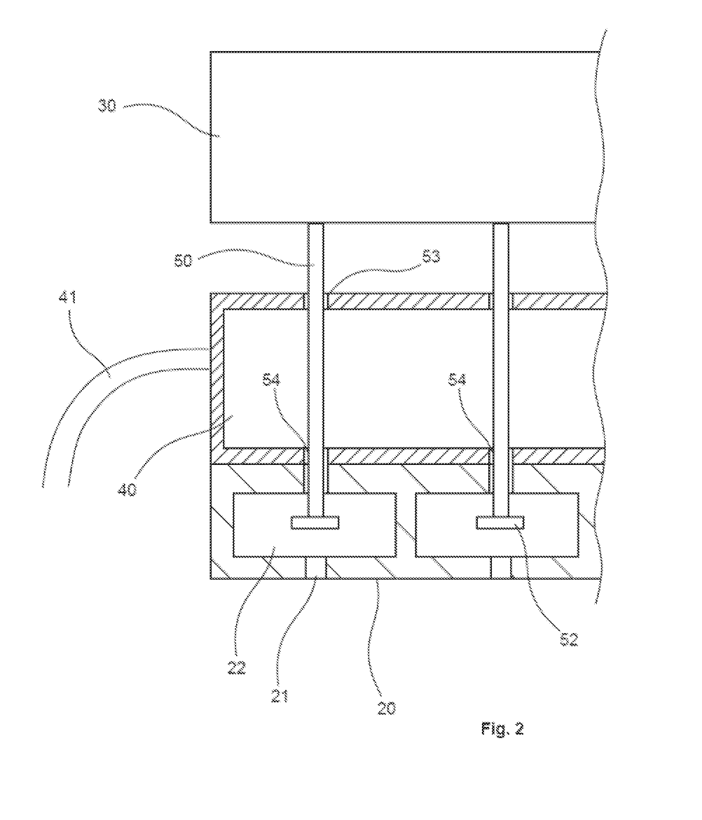

FIG. 2 shows an enlarged section of a vacuum gripper according to FIG. 1, depicting two outer air channels with their valves. The tappet receptacle 54 between the air channel 22 and the vacuum-source channel 40 as well as the tappet guide 53 are configured so as to be airtight and wear-free.

FIG. 3 shows a schematic depiction of the vacuum gripper according to FIG. 1, in a second cross section, showing an air channel 22 with several suction openings 21 arranged in it. The vacuum-source channel 40, the row of tappets and the actuator 30 extend perpendicular to the air channels, whereby they are located in the middle of the air channels in order to distribute the negative pressure from there uniformly to both sides of the air channel. In this cross section, FIG. 3 also shows a sealing plate 52 that, in this embodiment, closes two valve openings 51 and 51′ when the tappet 50 is raised.

In one embodiment, the tappet is pressed downward by a mechanical element of the actuator 30, which opens the valve by lowering the sealing plate 52 that then at least frees a valve opening. The tappet 50 is pushed against a spring force so that it is automatically raised again when it is no longer being pushed downward by an element of the actuator 30.

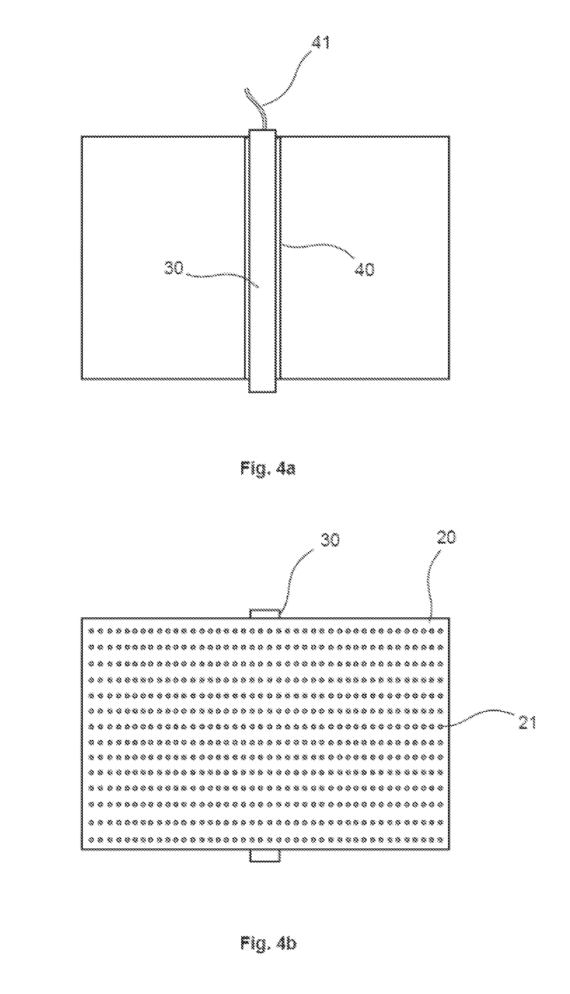

FIG. 4a shows a schematic depiction of the vacuum gripper according to FIG. 1, in a top view. The vacuum-source channel 40 and the actuator extend in the middle of the vacuum gripper 10, but they may not be mounted on a baseplate as add-on components, as is shown in the embodiment. Both components can also be integrated into the body or accommodated in a shared housing. FIG. 4b shows a schematic depiction of the vacuum gripper according to FIG. 1 in a bottom view, whereby the fourteen rows of suction openings that run perpendicular to the vacuum-source channel 40 are visible.

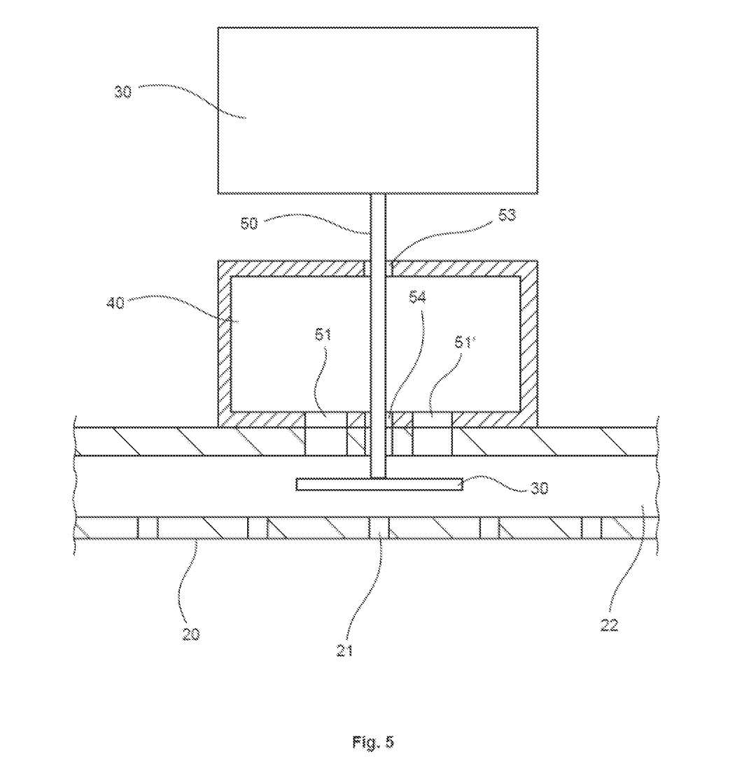

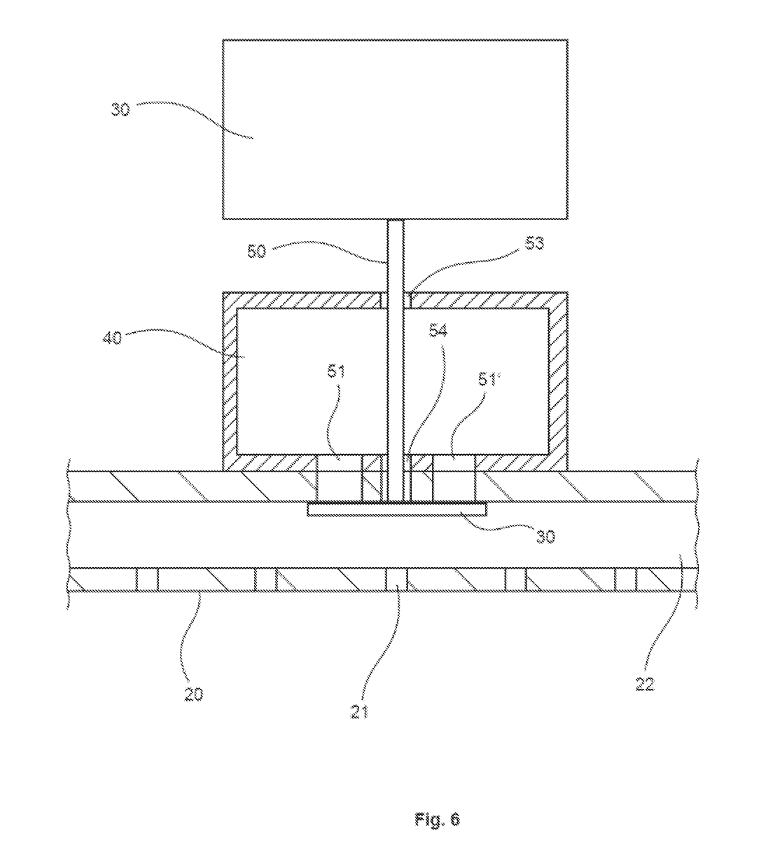

The mode of operation of the valves is shown in FIGS. 5 and 6, whereby FIG. 5 shows an enlarged section of the cross section according to FIG. 3, with the valve open. Here, the sealing plate 52 is lowered in the air channel 22 so that the valve openings 51 and 51′ are opened and pressure can be built up through the vacuum-source channel 40 in the associated air channel 22. In contrast, FIG. 6 shows an enlarged section of the cross section according to FIG. 3, with the valve closed, that is to say, with the sealing plate 52 raised.

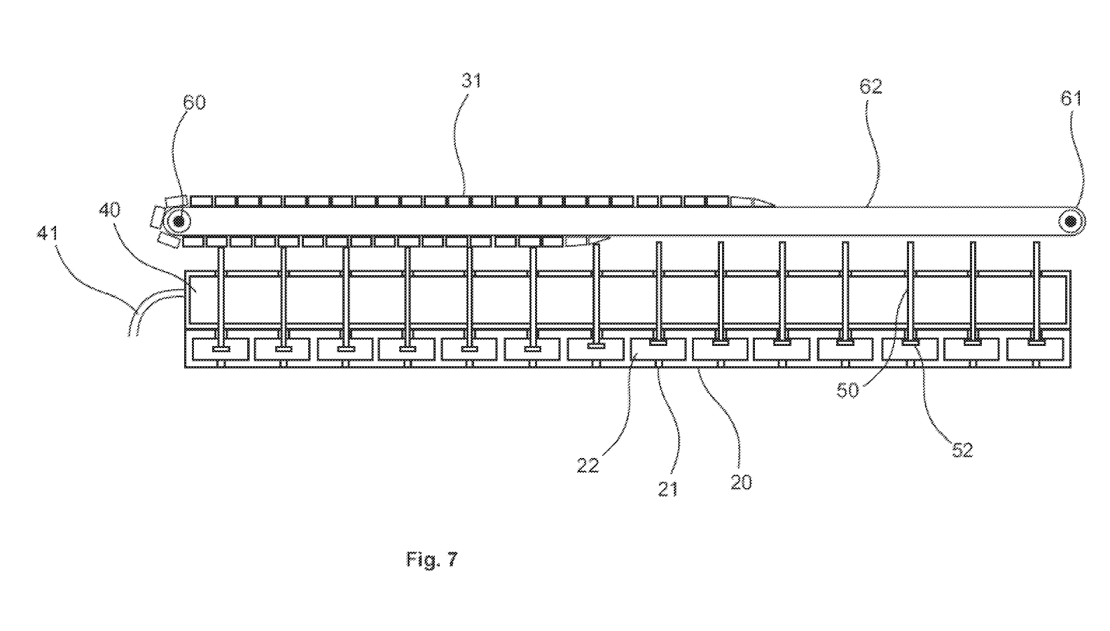

The mechanical actuation of the tappet 50 that serves to open and close the valves can be achieved in various ways. An embodiment of the vacuum gripper according to FIG. 1, with a possible mechanical actuator 30 is shown in FIG. 7. Here, the actuator 30 includes a control chain 62 that runs around at least two lateral deflection rollers 60 and 61. At least one of the deflection rollers is driven by a motor (not shown here) so that the control chain 62 is made to revolve around rollers. However, the control chain does not revolve around the deflection rollers continuously but rather cyclically. For the set-down cycle of several packaged items that had previously been picked up by the vacuum gripper, the control chain 62 revolves around the two rollers in one cycle.

The control chain 62 can be configured as a link chain, whereby the deflection rollers can be, for example, gear wheels. However, the control chain can also be, for example, a type of toothed belt. In order to be able to hold the control chain 62 in one line along the row of tappets, it is guided, for example, through lateral guides (not shown here).

Multiple control members 31 are installed in a row as control elements on the control chain 62. The control members 31 are attached so that they can tilt around a point on the control chain, thus allowing them to revolve around the deflection rollers 60 and 61, as is shown on the left of FIG. 7. The control members are attached to the control chain at a certain distance from each other. This distance must not be too large so as to still yield a continuous row of control members, whereby a distance of approximately has proven to be advantageous.

In an embodiment, at least the first and the last control members are configured with a surface that is slanted towards the control chain. In the embodiment shown in FIG. 7, the next-to-last control member has a slanted top, whereas the last control member is configured so as to be concave. Thus, each time, a bevel is formed by the last two control members.

When the control chain 62 revolves around the deflection rollers 60 and 61, the control members 31 reach the area of the tappets 50 and the actuator with the control chain is arranged above the row of tappets in such a way that they come into contact with the tappets and can push them down. Here, the length of the row of control members corresponds at least to the length of the row of tappets, so that all of the tappets can be pushed down by the control members when they are all in the area of the tappet (also see FIG. 7). In order for the row of control members to be able to make contact with, and incrementally push down, the next tappet, the bevel is provided on the first control members. The corresponding bevel on the last control members effectuates a gentle releasing of the last tappet each time.

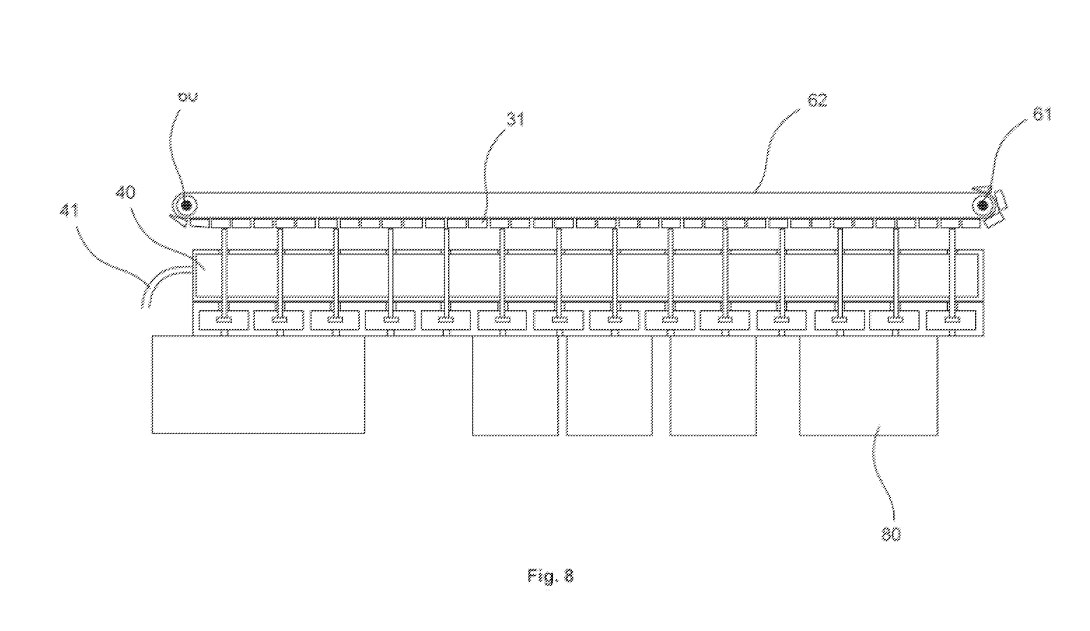

FIG. 8 shows the vacuum gripper with completely opened valves and several picked-up unit loads 80, whereby all of the control members 31 are in contact with the tappets and push them down so that the associated sealing plates free the valve openings in all of the air channels. The negative pressure of the vacuum-source channel 40 is distributed over all of the air channels and thus over all of the suction openings so that unit loads 80 can be picked up over the entire suction surface. In this position of the control members, the vacuum gripper is lowered onto a layer of unit loads and several packaged items 80 are picked up. Here, multiple unit loads can be picked up over the length of each air channel, which, however, is not shown in the drawing of FIG. 8.

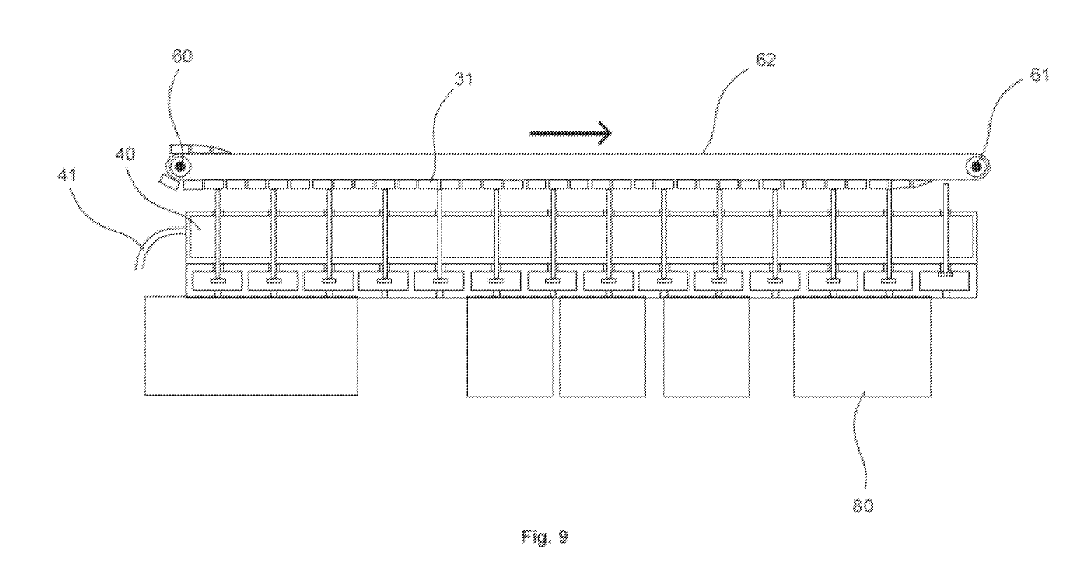

In this state, the vacuum gripper 10 can be swiveled or moved with the unit load to another position where the unit load is to be set down again. In order for this to be done row by row (sequentially) according to a fixed program, the control chain 62 is made to move at the beginning of the set-down cycle, as can be seen in FIG. 9, in order to vent the air channels consecutively, that is to say, in order to relieve the negative pressure. In this process, the control members 31 move to the left, as a result of which the pressure on the entire right-hand tappet is reduced, and this tappet moves upward due to the spring force being exerted. The sealing plate installed on the tappet likewise moves upward and closes the associated valve opening of the first, right-hand air channel. As a result, the air channel is no longer connected to the vacuum-source channel 40, which cancels the suction effect at the suction openings 21 of this air channel. Since no packaged item was picked up at this air channel, however, no packaged item is released here yet.

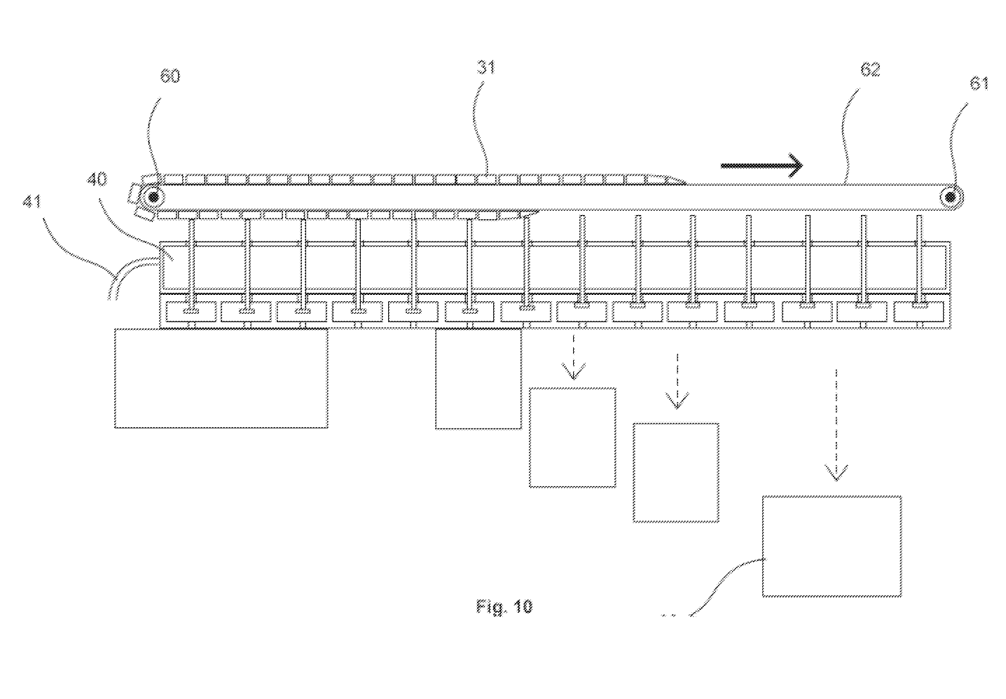

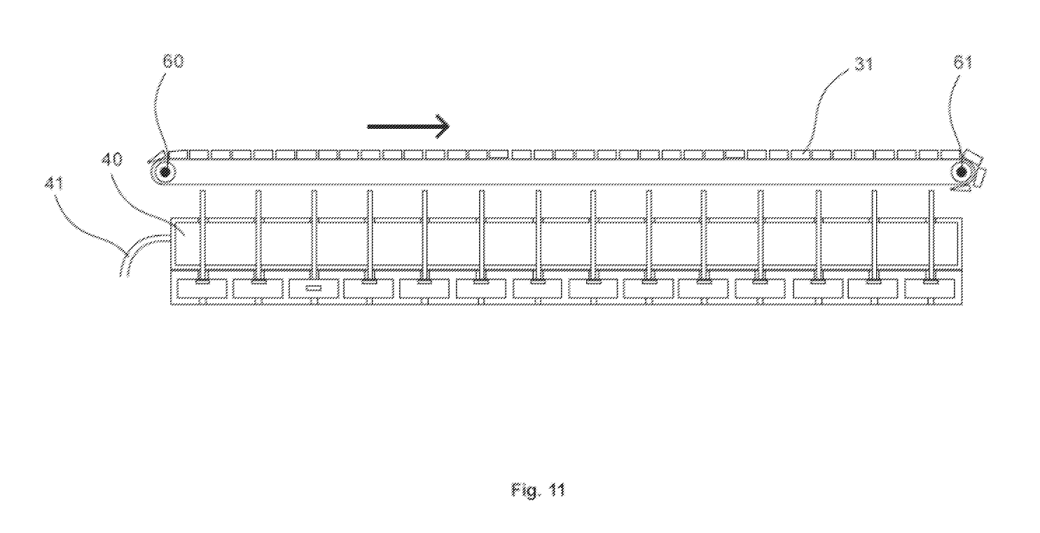

When the control members 31 continue to be moved by the driving action of the control chain 62, however, all of the tappets are moved upward along the row of tappets when the control members eliminate the pressure on the tappets and they move upward due to the spring force being exerted. FIG. 10 shows the vacuum gripper in approximately the middle of such a set-down cycle. Gradually, all of the air channels are vented sequentially and the packaged items drop as soon as the suction force of the suction openings in their area is reduced. FIG. 11 shows the vacuum gripper at the end of the set-down cycle, when all of the packaged items have dropped. In order to be able to once again pick up new unit loads, the control chain is moved further until it has once again reached the position shown in FIG. 9 and negative pressure is present at all of the air channels and associated suction openings. Here, the first tappet is once again pushed down gently by the first slanted control members of the row of control members.

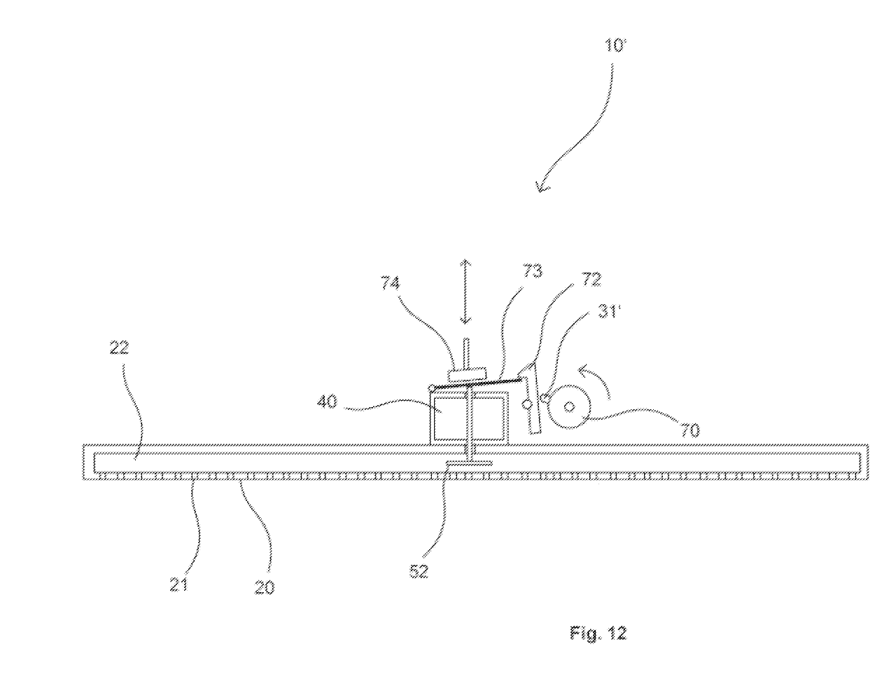

FIG. 12 schematically shows an embodiment of the vacuum gripper 10′ according to FIG. 1, with a mechanical actuator having a camshaft 70. Several cams 31′ are installed on the outer circumference of the camshaft 70 as control elements. The number of cams 31′ corresponds to the number of tappets 50 or the valves in the vacuum-source channel 40, so that each cam 31′ can actuate a valve.

The cams 31′ are arranged over the length of the camshaft 70 on the outer circumference of the camshaft 70 in such a way that, when the camshaft 70 rotates, the cams 31 consecutively make direct or indirect contact with the tappets 50, whereby the tappets 50 are contacted consecutively along the row of tappets. The cams 31′ are thus arranged on the camshaft 70 in a line that winds once around the camshaft 70. Fourteen cams are evenly distributed over 360°.

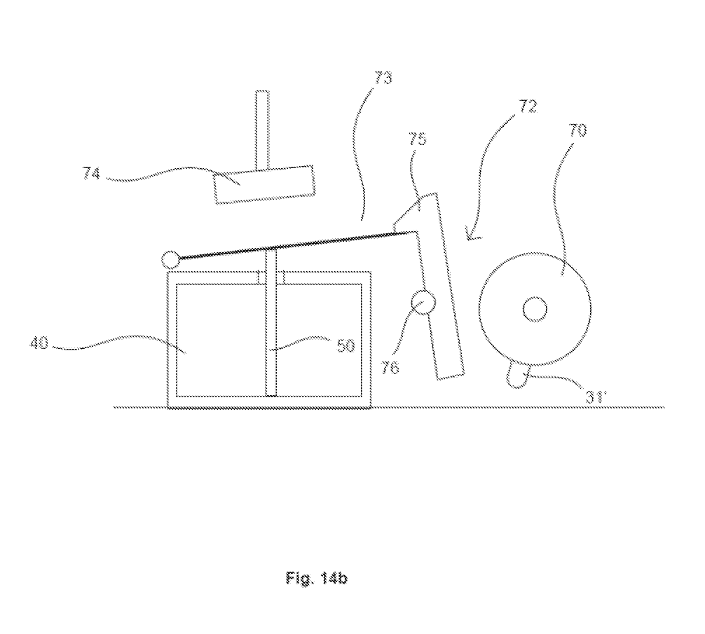

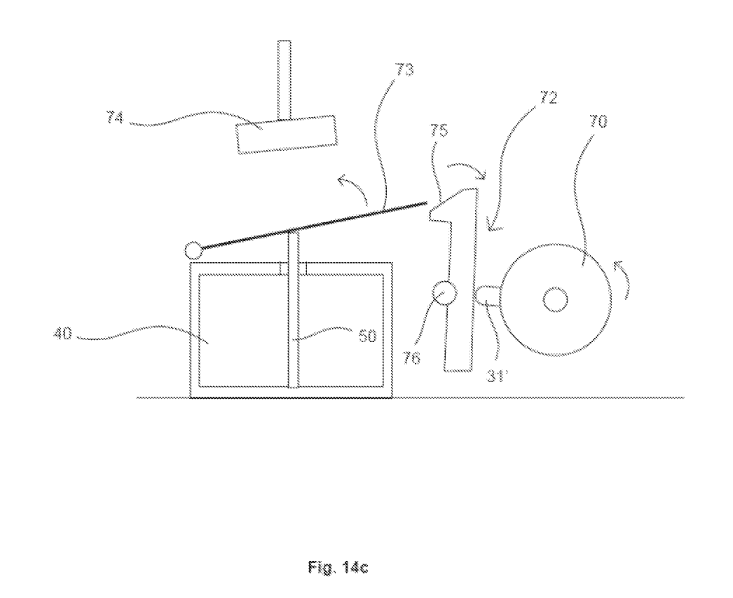

The cams 31′, as control members, may effectuate the closing of a valve, that is to say, in the embodiment of the vacuum gripper according to FIG. 1, the lifting of a tappet 50. In the embodiment shown in FIG. 12, the contact of the cams 31′ with the tappets is made indirectly via an associated tilting lever 73 and a catch 72, as is shown in an enlarged section in FIG. 14a. A tilting lever 73 that is in contact with the tappet tip is arranged above each tappet 50. The tappet tip may be pushed by the means for automatically returning the tappets to an upper position in which the associated valves are closed and in which the tappet lifts the tilting lever 73. Therefore, by lowering the tilting lever 73, the tappet is lowered and the associated valve is opened, as a result of which spring force against the tilting lever 73 is built up.

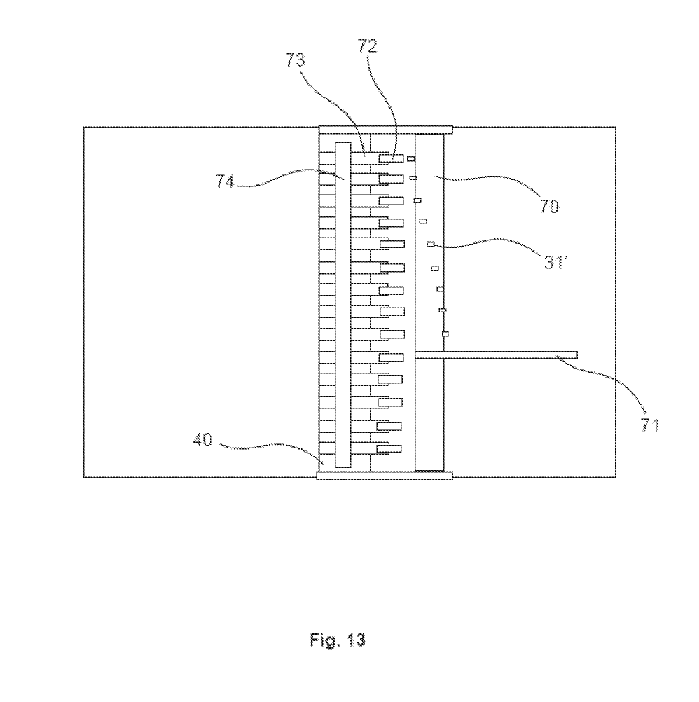

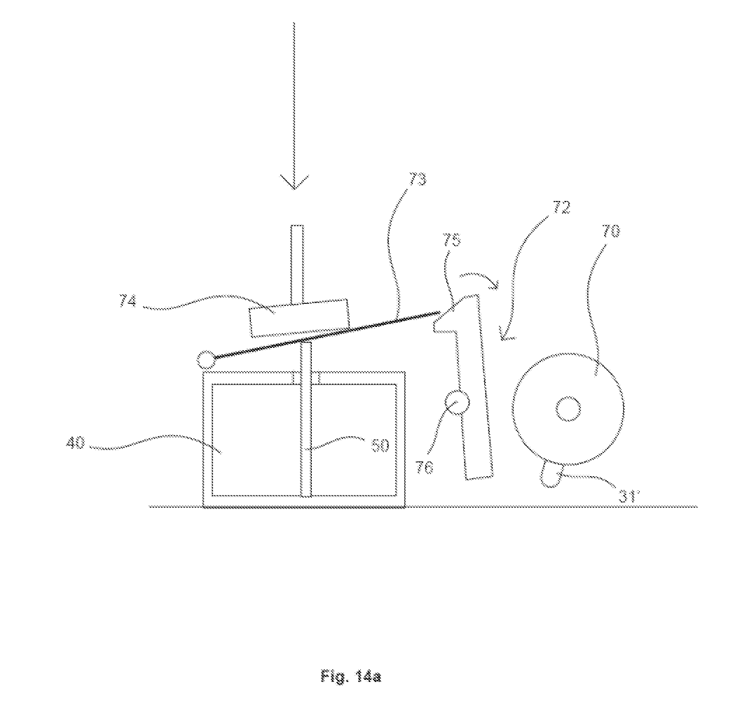

All of the tilting levers 73 are lowered, for example, by a shared closing bar 74, which extends over all of the tilting levers 73, as is shown in a top view in FIG. 13. By lowering the closing bar 74, all of the tilting levers 73 are pushed down. In order for them to remain in this position, a catch 72 with a latch 75 is provided for each tilting lever 73. Each of these catches 72 is swivel-mounted around a shared axis of rotation 76 due to the spring force. The latch 75 is located at one end of the catch 72, whereas there is a contact area for making contact with a cam 31′ on the other end of the catch 72. The latch 75 is configured so as to be hook-shaped with a slanted upper edge.

The camshaft 70 may be rotatably mounted between two lateral bearings. It runs next to the row of tappets and is made to rotate, for example, by a drive chain 71 that engages with the circumference of the camshaft 70, as can be seen in FIG. 13, in a top view of the vacuum gripper. However, any other suitable types of drive can also be used.

When the tilting levers 73 are lowered by the closing bar 74, each tilting lever 73 exerts pressure on the slanted upper edge of a latch 75 of a catch 72. The catch 72 in question yields to this pressure in that it swivels slightly around its axis of rotation 76, as is shown in FIG. 14a. In this process, the catch 72 swivels so far until the tilting lever 73 arrives underneath the latch 75 and the catch 72 swivels back into its starting position due to the spring force. Due to the hook-like shape of the latch 75, the tilting lever 73 can no longer be lifted, in spite of the spring force of the spring-mounted tappet, but rather is held by the catch in the position in which the valve is open.

The camshaft 70 is attached relative to the catches 72 in such a way that its cams 31′ consecutively strike the contact area of each catch when the camshaft 70 rotates. The contact of a cam 31′ with the contact area of a catch is shown in FIG. 14c. Here, the closing bar 74 was first lifted, so that it now no longer exerts pressure on the tilting lever. When the cam 31′ pushes against the lower contact area of the catch 72, the catch 72 swivels around its rotational axis 76 and releases the tilting lever 73. Due to the means for automatically returning the tappet 50 upwards, the tilting lever 73 is pushed upward by the tappet 50. When the cam 31′ has passed the catch 72, it swivels back into its starting position due to the spring force. Since the cam 31′ is wound around the camshaft 72, the second cam then strikes the second catch after the first cam has struck against the first catch. As a result, the same procedure now takes place for the next valve and a sequential closing of the valves that are associated with the catches is achieved. The valves remain in this state until they are opened again by lowering the closing bar.

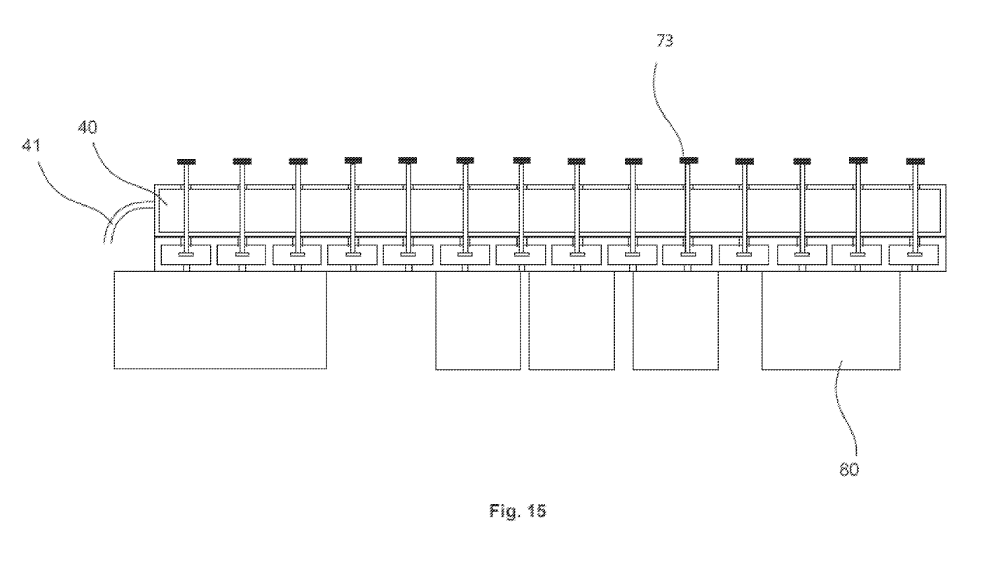

The procedures of picking up and setting down unit loads with this embodiment of the vacuum gripper 10′ are explained on the basis of FIGS. 15 to 18. In this context, however, the actuator is not shown with all if its details but rather, its mode of operation is shown in simplified form by the different positions of the tilting levers 73. FIG. 15 shows the vacuum gripper with completely open valves and picked-up unit loads 80. All of the tilting levers 73 were previously pushed down by the closing bar and are latched into their catches. In this state, the tappets 50 are pushed downward so that the associated sealing plates free the valve openings in all of the air channels. The negative pressure of the vacuum-source channel 40 is distributed over all of the air channels and thus over all of the suction openings, so that unit loads 80 can be picked up over the entire suction surface. In this position of the control members, the vacuum gripper is set down onto a layer of unit loads and several packaged items 80 are picked up. In this process, multiple unit loads can be picked up over the length of each air channel, which, however, is not shown in the drawing in FIG. 15.

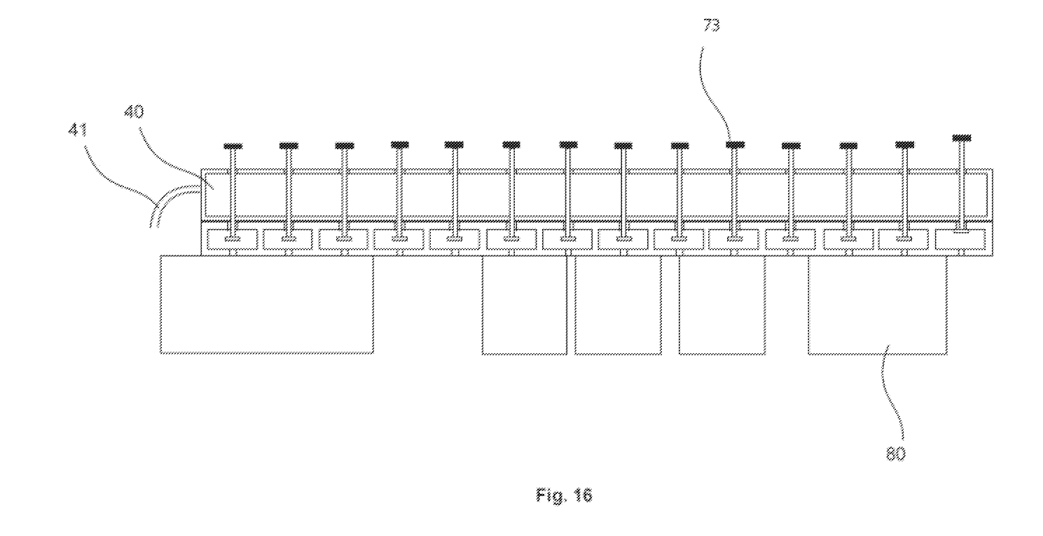

In this state, the vacuum gripper can be swiveled or moved together with the unit load to another position, where the unit load is to be set down again. In order for this to be done row by row (sequentially) according to a fixed program, the camshaft 70 is made to rotate by one revolution in order to vent the air channels consecutively, that is to say, in order to relieve the negative pressure. When the first cam strikes the beginning of the camshaft 70 at the contact area of the first catch, the catch swivels around its axis of rotation and the latch releases the associated tilting lever. Due to the automatic return of the tappets, the tappet is lifted and the tilting lever is likewise pushed upward. The sealing plate installed on the tappet moves upward and closes the associated valve opening of the first, right-hand air channel. As a result, the air channel is no longer connected to the vacuum-source channel 40, which eliminates the suction effect at the suction openings 21 of the air channel. This beginning of the set-down cycle is shown in FIG. 16. Since no packaged item was picked up at this air channel, however, no packaged item is released here yet.

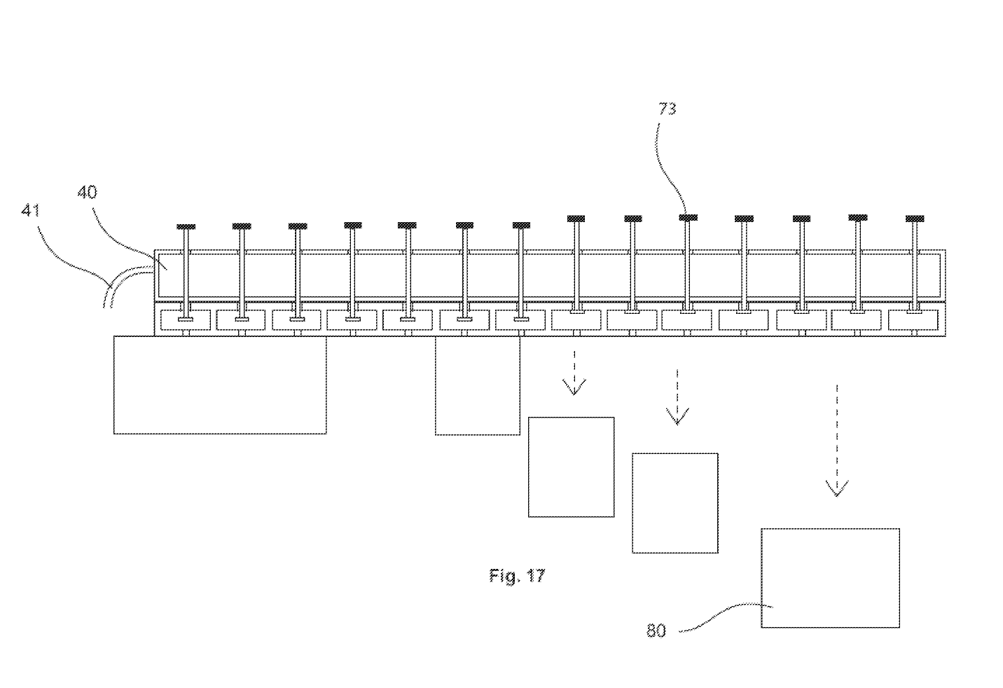

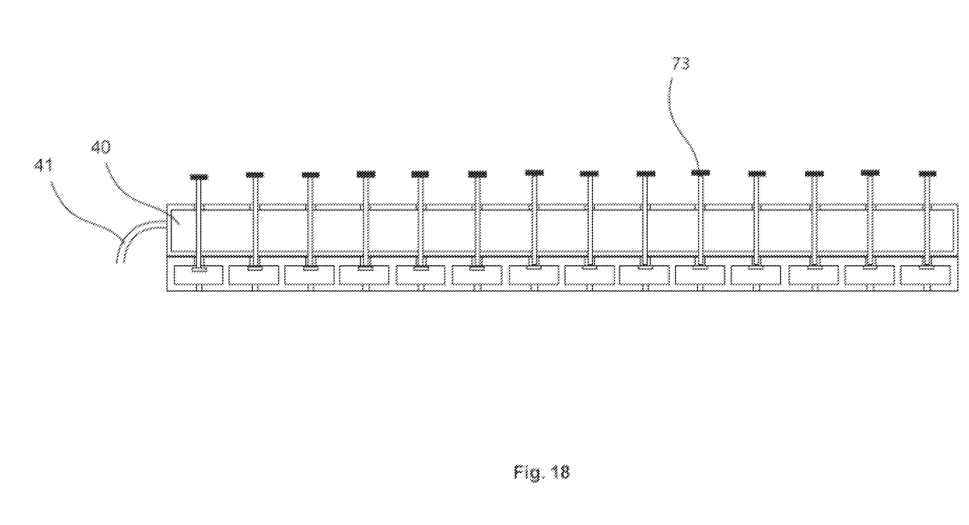

When the camshaft is rotated further, the next cams consecutively strike each of the next catches, release a tilting lever and thereby close the associated valve. FIG. 17 shows the vacuum gripper approximately in the middle of such a set-down cycle. Gradually, all of the air channels are vented sequentially and the packaged items drop as soon as the suction force of the suction openings in their area is reduced. FIG. 18 shows the vacuum gripper at the end of the set-down cycle, when all of the packaged items have been dropped.

In order to be able to once again pick up new unit loads, the closing bar is lowered, as a result of which the tappets are also lowered and the valves are opened once again. The tilting levers latch under the catches and the valves are thus kept open. In this state, negative pressure can be applied again at all of the air channels during the next pick-up cycle, and consequently, packaged items can be picked up.

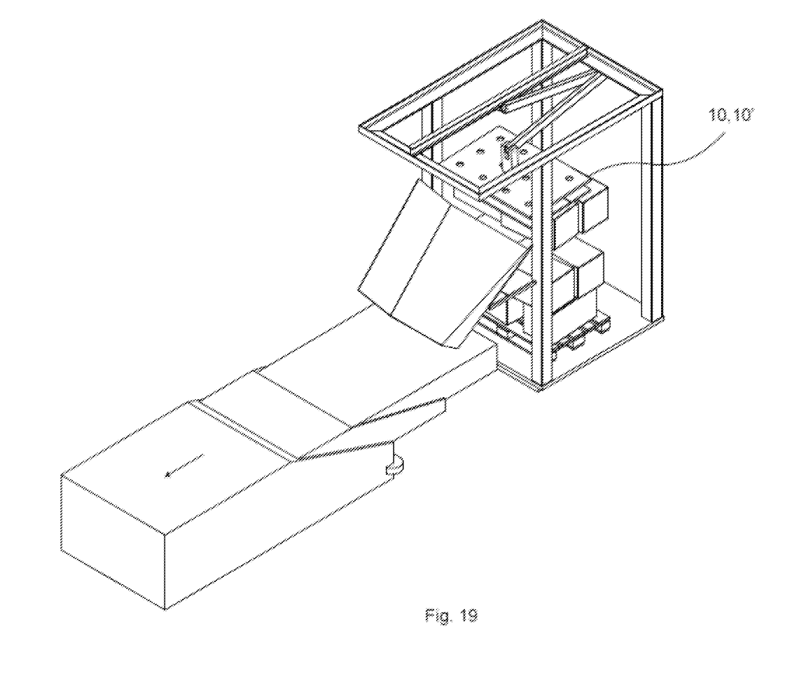

FIG. 19 shows a possible use of the vacuum gripper 10, 10′ according to an embodiment, in a de-palletizing installation. Such an installation is described, for example, in German laid-open document DE 10 2006 062 528 A1. The vacuum gripper is lowered onto a pallet with several layers of unit loads and it picks up several packaged items. Then, the vacuum gripper is swiveled into a position above a conveyor belt and the air channels are vented one row at a time. As a result, the packaged items drop consecutively or in smaller groups from the vacuum gripper onto the conveyor belt. A previously picked-up layer of packaged items is thus individuated with mechanical means, without having to use complicated and malfunction-prone sensor systems.

1-15. (canceled)

16. A vacuum gripper for picking up unit loads one layer at a time and setting them down sequentially, comprising:
a suction surface having a plurality of suction openings, wherein the suction openings are connected to a vacuum source; and
an actuator for temporarily connecting the suction openings to the vacuum source, wherein the vacuum gripper comprises at least two air channels that each connect several suction openings to each other, wherein each air channel comprises at least one valve with a central, rectilinear vacuum-source channel that is connected to a vacuum source, and wherein the at least one valve comprises at least one tappet whose movement can control opening and closing of the at least one valve, and wherein the at least one tappet is automatically moved into a position where an associated valve is closed, and the tappets are arranged in a straight row of tappets, and wherein, in order for the tappets to be actuated, the tappets are functionally connected to a mechanical actuator that extends along the straight row of tappets, and wherein the mechanical actuator comprises mechanically movable control elements for sequentially actuating the tappets, wherein the mechanically movable control elements are configured to consecutively actuate automatically returning the tappets into a position where the associated valve is closed, as a result of which associated valves along the row of tappets can be closed.

17. The vacuum gripper of claim 16, wherein the mechanical actuator comprises a driven control chain that runs around at least two deflection rollers and that extends along the row of tappets, and wherein several control members in a row of control members are attached as control elements to the driven control chain in such a way that the control members are directly or indirectly in contact with a tappet, thereby moving the tappet into a position in which the associated valve is opened when a control member is in a vicinity of the associated tappet when the driven control chain is running around the two deflection rollers, whereas the tappet can be moved by a means for automatically returning the tappets to a position in which the associated valve is closed if no control member is present in the vicinity of the tappet.

18. The vacuum gripper of claim 17, wherein the control members are configured to be rectangular-shaped and are arranged next to each other along the driven control chain in a row of control members in such a way that a length of the row of control members corresponds to at least the length of the row of tappets.

19. The vacuum gripper of claim 18, wherein a first control member and a last control member of the row of control members have a top that is slanted towards the driven control chain.

20. The vacuum gripper of claim 19, wherein the driven control chain runs in at least one guide rail.

21. The vacuum gripper of claim 20, wherein two running segments of the driven control chain formed between the two deflection rollers are located in one plane with the row of tappets.

22. The vacuum gripper of claim 16, wherein the mechanical actuator has a driven camshaft that extends along the row of tappets, whereby several cams are installed as control elements offset with respect to each other along an outer circumference of the driven camshaft in such a way that, when the driven camshaft turns, the cams make contact with the tappets directly or indirectly along the row of tappets, thereby consecutively moving the tappets into a position in which the associated valve is closed, wherein the cams actuate the means for automatically returning the tappets to a position in which the associated valve is closed, and a number of cams corresponds to at least a number of tappets.

23. The vacuum gripper of claim 22, wherein the cams are each indirectly in contact with the tappets via a catch and a tilting lever, and wherein a swivel-mounted tilting lever is disposed above each tappet, wherein the swivel-mounted tilting lever makes contact with the tappet, and a catch is spring-mounted around a centered axis of rotation, whereby the catch has a hook-shaped latch on one end and a contact area on an other end, and wherein the swivel-mounted tilting lever can be moved by a closing bar into a position in which a swiveling end of the swivel-mounted tilting lever extends underneath a latch of the associated catch and latches under the latch, and wherein, when the driven camshaft rotates around its longitudinal axis, the cams consecutively make contact with the contact area of each catch, and wherein contact of a cam with a contact area of each catch causes the catch to rotate around its axis of rotation, as a result of which the associated swivel-mounted tilting lever is released from the latch and an actuator for automatically returning the tappets to a position in which the associated valve is closed.

24. The vacuum gripper of claim 23, wherein the driven camshaft is rotated by a drive chain that engages with the outer circumference of the driven camshaft.

25. The vacuum gripper of claim 24, wherein the closing bar extends over all swivel-mounted tilting levers, and all of the swivel-mounted tilting levers can be moved simultaneously by the closing bar into a position in which a swiveling end of each swivel-mounted tilting lever extends underneath the latch of the associated catch and latches under the latch.

26. The vacuum gripper of claim 25, wherein an actuator for automatically returning the tappets to a position in which the associated valve is closed comprise a spring mounting of the tappets.

27. The vacuum gripper of claim 26, wherein the vacuum gripper comprises a body, and wherein at least one valve opening is made in this body for each valve in an area of the vacuum-source channel, wherein a valve opening of the valve connects the vacuum-source channel to an associated air channel, and wherein the valve can be opened and closed by a valve body, whereby a tappet installed on the valve body passes through a tappet guide in the vacuum-source channel and leads out of the vacuum-source channel, wherein the valve body can be contacted by the control elements of the mechanical actuator outside of the vacuum-source channel.

28. The vacuum gripper of claim 27, wherein the valve body is a sealing plate with which the valve opening can be closed.

29. The vacuum gripper of claim 28, wherein the sealing plate is located inside an air channel, and a tappet installed on the sealing plate passes through a tappet receptacle out of the air channel into the vacuum-source channel and through the tappet guide out of the vacuum-source channel, wherein the sealing plate covers a valve opening from a side of the air channel and releases the valve opening when the associated tappet is moved.

30. The vacuum gripper of claim 29, wherein an actuator for automatically returning the tappets to a position in which the associated valve is closed is configured such that the actuator pushes the sealing plate, together with the tappet, in a direction of the mechanical actuator.
